(19) United States
(12) Patent Application Publication
(10) Pub. No.: US 2015/0081133 A1
(43) Pub. Date: Mar. 19, 2015

(54) GESTURE-BASED SYSTEM ENABLING CHILDREN TO CONTROL SOME VEHICLE FUNCTIONS IN A VEHICLE

(71) Applicant: Toyota Motor Sales, U.S.A., Inc., Torrance, CA (US)

(72) Inventor: Jason A. Schulz, Redondo Beach, CA (US)

(21) Appl. No.: 14/447,465

(22) Filed: Jul. 30, 2014

Related U.S. Application Data
(63) Continuation-in-part of application No. 14/180,563, filed on Feb. 14, 2014.
(60) Provisional application No. 61/878,898, filed on Sep. 17, 2013.

(51) Int. Cl. B60W 50/10

(52) U.S. Cl. CPC B60W 50/10
USPC 701/1

(57) ABSTRACT

A system for a vehicle is configured to enable young children to control certain vehicle functions such as audiovisual, entertainment or temperature control functions. In different variations, the system can detect the presence of a child in a rear vehicle seat, determine whether the child a specific child known to the system and then accordingly grant vehicle function control permissions. The system can detect, interpret, and execute gesture commands issued by a child. In many instances, useable gesture commands can be sufficiently simple that they are understandable to and reproducible by children even as young as toddlers. In general, the operation of the system can decrease driver distraction by freeing a driver of the need to operate vehicle functions on behalf of children.

### CROSS-REFERENCE TO RELATED APPLICATIONS

This application claims priority to U.S. Provisional Application 61/878,898, filed Sep. 17, 2013 and is a continuation-in-part of U.S. patent application Ser. No. 14/180,563, filed Feb. 14, 2014, which claims priority to U.S. Provisional Application No. 61/878,898, filed Sep. 17, 2013, each of which is incorporated herein by reference.

### BACKGROUND

The present disclosure relates to a vehicle and more particularly to systems and methods which enable young children to control certain vehicle functions.

Young passengers riding in vehicles can at times become restless and noisy, causing driver distraction. Modern vehicles often contain entertainment systems, such as rear seat DVD displays or other audiovisual entertainment systems, which can decrease driver distraction by providing entertainment or other engagement for young passengers thereby minimizing restless back seat behavior. Frequently however, such systems are not amenable to direct control by young children. When the driver is required to control such systems on childrens' behalf, this can increase driver distraction. Even child-oriented systems with voice recognition or child-friendly controls such as touch screens or the like may not be amenable to young children not-yet-developed speaking ability or manual motor skills

Research related to young children and sign language indicates that in some cases children even as young as six months can learn and understand rudimentary sign language or gesture-based communication. Young children who have started to speak but have imperfect pronunciation or limited speaking vocabularies are capable of learning and understanding fairly extensive sign language or gesture-based communication.

### SUMMARY

A system for a vehicle is configured to enable child control of vehicle functions. The system includes a detection subsystem and a control subsystem. The detection subsystem can be configured to detect the presence of a child in a vehicle passenger seat and to detect user commands such as hand gesture commands issued by a child. The control subsystem, which is in communication with the detection subsystem, is configured to enable a user to control at least one vehicle function. In many cases, the system additionally includes a response subsystem, such as an audiovisual entertainment system or a temperature control system.

A method for enabling child control of vehicle functions can include a step of equipping a control system, for installation in a vehicle, with a detection subsystem and a control subsystem. The detection subsystem can include at least one child detection sensor and at least one command sensor and the control subsystem can be configured to enable a child to control at least one vehicle function. The detection subsystem can be operable to transmit command data to the control subsystem and the control subsystem can be operable to receive and interpret the command data.

A vehicle which possesses a system configured to enable a child to control vehicle functions can include a detection subsystem and a control subsystem. The detection subsystem can be configured to detect the presence of a child in a vehicle passenger seat and to detect user commands such as hand gesture commands issued by a child. The control subsystem, which is in communication with the detection subsystem, is configured to enable a user to control at least one vehicle function. In many cases, the system additionally includes a response subsystem, such as an audiovisual entertainment system or a temperature control system.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an overhead interior plan view of a vehicle having a system for child control of vehicle functions;

FIG. 2 is a partial interior view of the vehicle with components of a detection subsystem which is a portion of the system for child control of vehicle functions;

FIG. 3 is a schematic representation of the operation of the system for child control of vehicle functions; and

FIG. 4 is a block diagram illustrating an example of a control algorithm useable by the system for child control of vehicle functions.

### DETAILED DESCRIPTION

The present disclosure describes a system and method to reduce driver distraction by enabling children as young as toddlers to control certain vehicle systems such as entertainment systems. By engaging children in the riding experience and freeing drivers of the need to choose and play videos, change music, adjust temperature, etc., the embodiments described herein create an interactive environment for children and allow drivers to focus on the road.

The various embodiments described herein generally include a variety of sensors enabled to detect the presence of a child in a vehicle seat, and to detect gesture commands issued by the child. These sensors are in communication with a control module tasked with interpreting the gesture commands. The control module will typically have access to a command database, which it uses to match known commands to the child's detected gestures. The control module will then relay the commands to various execution systems, such as audio/visual systems or temperature control systems.

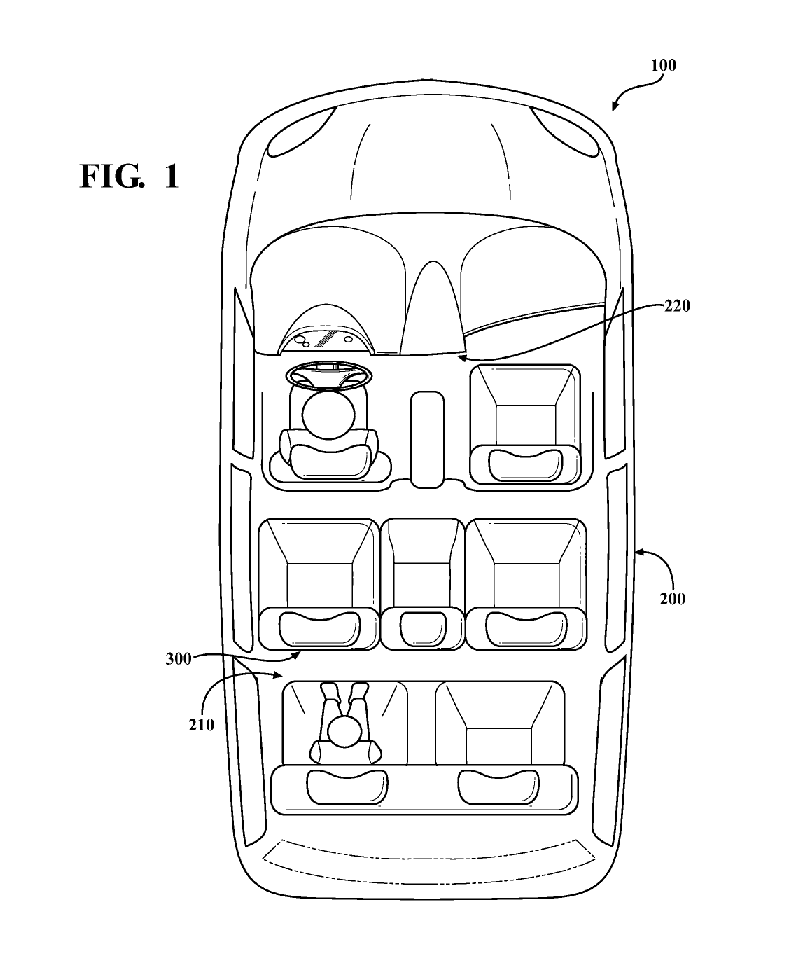

Referring now to FIG. 1, a vehicle 100 includes a system 200 configured to facilitate the control of vehicle functions by a child. The term “child” as used here refers generally to any minor. But as will become apparent, the system 200 is particularly suited in certain of its operations to facilitate the control of vehicle functions by a young child who has difficulty operating conventional devices such as those controlled by buttons or knobs. In certain of its operations, the system 200 is particularly suited to facilitate control of vehicle functions by a child who is too young to speak.

With continuing reference to FIG. 1, the system 200 includes a detection subsystem 210, configured to detect the presence of a child and to detect user commands. The system additionally includes a control subsystem 220, configured to interpret user commands and to control vehicle functions. The detection subsystem 210 and the control subsystem 220 are in communication with one another.

It should be understood that, while FIG. 1 illustrates the detection subsystem 210 as being generally located on the left side of the last row of a three seat vehicle, elements of the detection subsystem 210 can be located anywhere in a vehicle 100 interior, such as in any seat, or anywhere within a headliner, floor liner or door panel, for example. Similarly, while the control subsystem 220 is illustrated as being generally located in the vicinity of a vehicle 100 control panel or head unit, elements of the control subsystem 220 can be located anywhere throughout the vehicle.

The detection subsystem 210 includes at least one child detection sensor 212, configured to detect the presence of a child in a vehicle passenger seat. As used herein, the phrase “vehicle passenger seat” refers to any appropriate seating area in the vehicle 100 other than the driver's seat, but particularly refers to a second or third row seat or any seat not in the driver's seat row. A child detection sensor 212 can include a seat pressure sensor, an imaging sensor such as a closed-circuit television camera detecting two-dimensional or three-dimensional video image data, an audio sensor, or any other device capable of detecting physical properties of a child useful to distinguish a child from an adult. In many instances, more than one child detection sensor 212 will be deployed throughout the vehicle.

The detection subsystem 210 also includes at least one command detection sensor 214, configured to detect commands issued by a user and to transmit data relating to said commands. In some variations, the commands to be detected by any given command detection sensor 214 can include visible commands, such as facial expression commands or hand gesture commands. In the same or other variations, the commands to be detected by any given command detection sensor 214 can include audible commands, such as uttered words or other sounds. Suitable examples of a gesture detection sensor can include a two-dimensional or three-dimensional imaging sensor capable of detecting user issued commands, in particular gesture commands.

It should be understood that in some instances the same device can function as both a child detection sensor 212 and a command detection sensor 214. For example, an imaging sensor could detect the presence of a child in a seat and detect gesture commands issued by the child. In other instances, a child detection sensor 212 and a command detection sensor 214 can be different devices. In various instances, any given seat in the vehicle 100 can have more than one child detection sensor 212 deployed to detect the presence of a child in that particular seat. In some instances of such a deployment, child detection can proceed through a first determination event indicating the possible presence of a child in the seat, followed by a second detection event confirming the presence of a child in the seat.

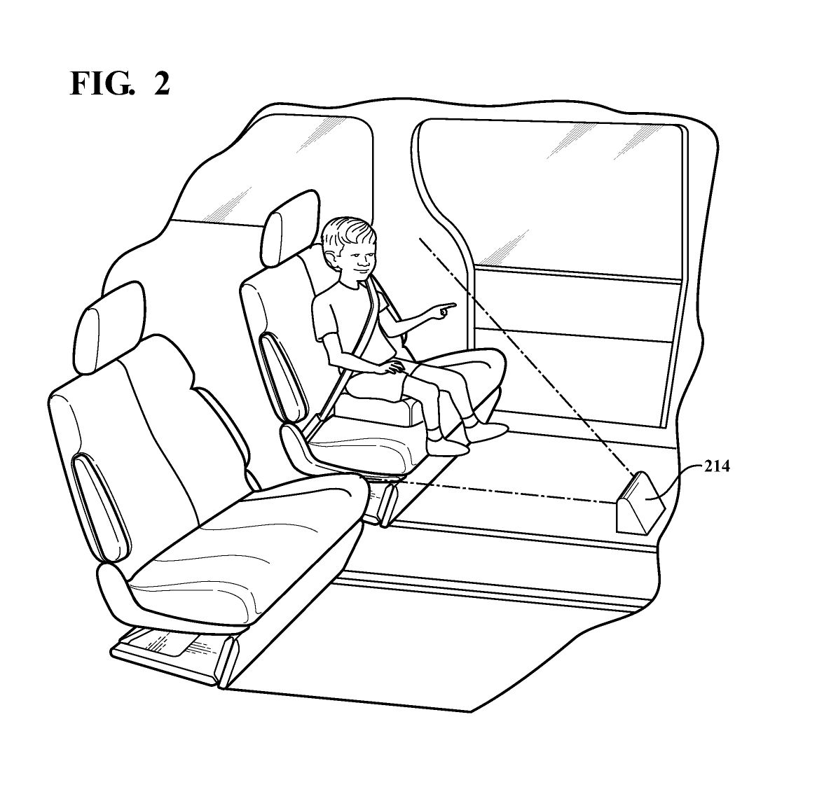

As an example of the latter scenario, in a first determination a child detection sensor 212, such as a seat pressure sensor could indicate the possible presence of a child in a vehicle passenger seat, for example by detecting a weight between 30 and 100 pounds disposed on a rear passenger seat. A second child detection sensor 212, such as an imaging sensor properly positioned to have a viewing field encompassing the seating area, could be activated by this first determination. The activated second child detection sensor can then monitor the field of view for imaging data consistent with the presence of a child. FIG. 2 shows a somewhat stylized, partial interior view of a vehicle having an imaging sensor in the floor functioning as a command detection sensor 214. As noted above, the imaging sensor of FIG. 2 can also be functioning as a child detection sensor 212.

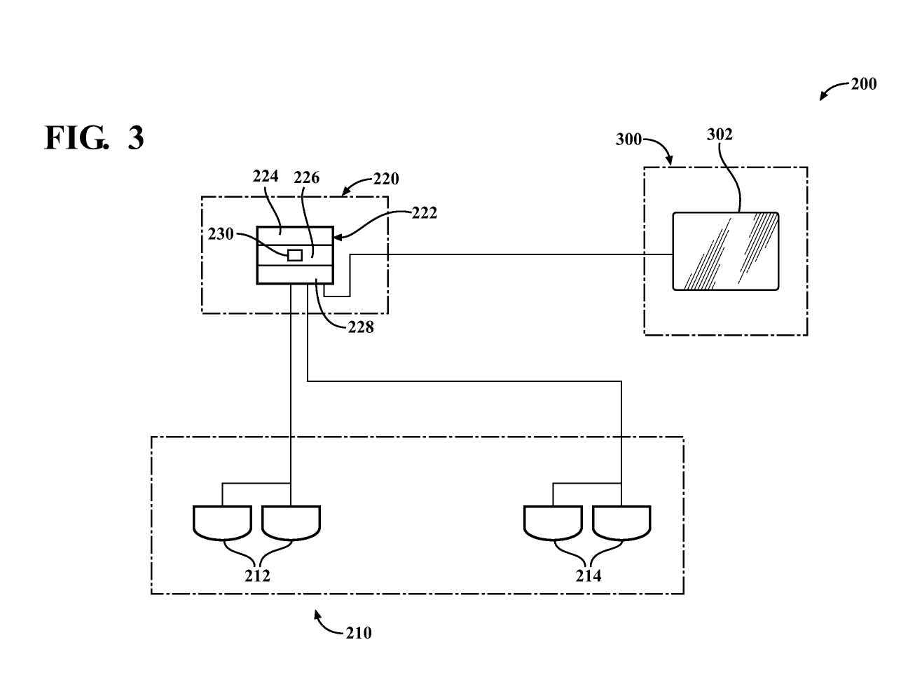

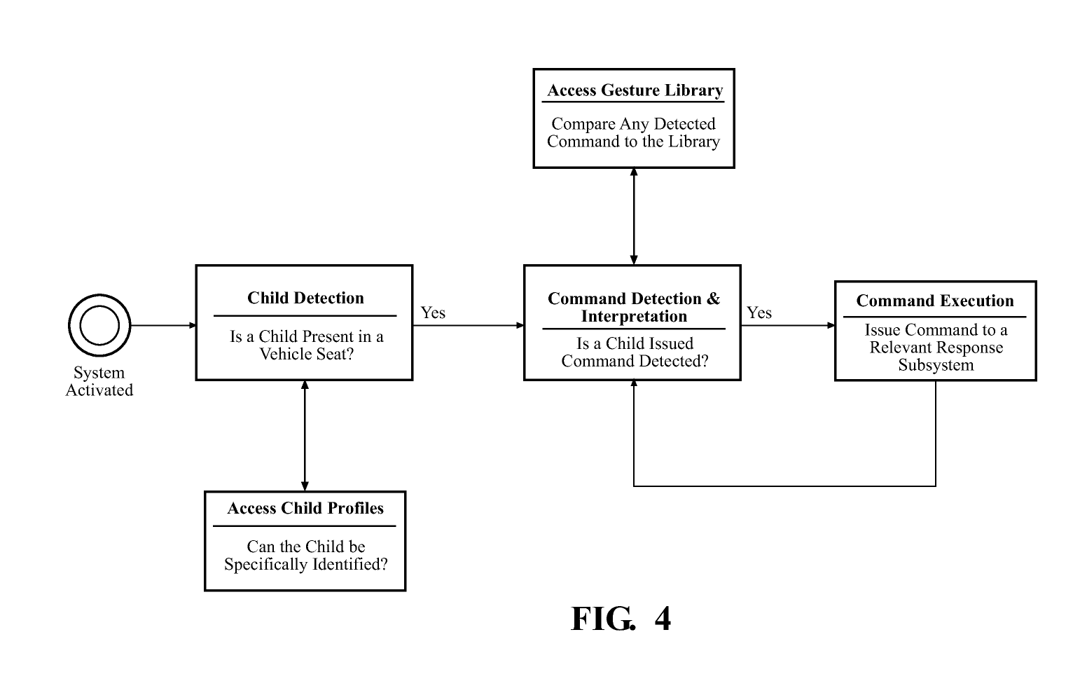

With reference to FIG. 3, the control subsystem 220 can generally include a control module 222 with a processor 224, a memory 226, and an interface 228. The processor 224 may be any type of microprocessor having desired performance characteristics. The memory 226 can include any type of computer readable medium which stores the data and control algorithms described herein or otherwise useful to system 200. The functions of an control algorithm that can be included in memory 226 are illustrated in FIG. 4 in terms of a functional block diagram. It should be understood by those skilled in the art with the benefit of this disclosure that these functions may be enacted in either dedicated hardware circuitry or programmed software routines capable of execution in a microprocessor based electronics control embodiment.

In some instances, control algorithm can include or access additional algorithms or libraries, such as a gesture command library and/or a gesture interpretation algorithm. For example, the memory 226 can include a gesture command library containing all gesture commands interpretable by the system 200. Upon receipt of data from a command detection sensor 214 of the detection subsystem 210, such a control algorithm and/or a gesture interpretation algorithm would compare the received data to data stored in the gesture command library to determine whether an executable command had been detected.

With continued reference to FIG. 3, the control module 222 may be a portion of a central vehicle control, a stand-alone unit, or other system such as a cloud-based system. Other operational software for the processor 224 may also be stored in the memory 226. The interface 228 facilitates communication with other subsystems such as the detection subsystem 210 or a response subsystem 300 discussed below.

In many instances, the system 200 will further include a response subsystem 300 in communication with the control subsystem 220. The response subsystem 300 is identifiable with the vehicle function that is subject to control by the system 200. For example, the response subsystem 300 could be an audiovisual system or a temperature control system. In the examples of FIGS. 1-3, the illustrative examples of the response subsystem 300 is an audiovisual system such as can play videos, music, or other audiovisual entertainment for a child sitting in a rear passenger seat.

In some variations, the system 200 can store child profiles containing identification and/or permissions data relating to specific children, categories of children, or both. For example, in a vehicle 100 which routinely carries three specific children, the system 200 could store a child profile for each of those three children. Each child profile can contain, for example, weight data, skeleton joint relationship data, or facial recognition data useable by the system to specifically identify each child when present as a passenger in the vehicle 100. Each child profile can additionally contain permissions data indicating what vehicle functions that child may control or the extent to which s/he may control them. For example, a younger child could have permissions to only control a video playback system directed to his/her seat, while an older child has permissions to control a video playback system as well as localized temperature control system.

Optionally, a driver, parent or other vehicle user can input or edit child profiles either through a direct interaction with vehicle controls or remotely such as through a remote personal computer or mobile device application. For example, if a parent/driver discovers that a child passenger routinely misuses the system 200, the parent/driver can edit that child's profile to restrict control permissions. In other variations, a parent/driver can reversibly deactivate the system 200.

Following now is an exemplary scenario to further illustrate the use and some operational features of the system 200. A parent places two children, ages two and five, in the back seats of a family minivan. The parent gets in the driver's seat and begins driving. System 200 can be activated at various times, such as when the children are placed in their seats, when main vehicle electrical power is engaged, when the parent begins driving, or at another suitable time. Upon activation of system 200, pressure sensors in the two rear seats, operating as child detection sensors 212, detect twenty-five and fifty pounds pressure, respectively in the two seats. These data are sent to the control subsystem 220 which determines that the data are consistent with the presence of children in the two seats. The control subsystem 220 further accesses stored child profiles and determines the data are consistent with two specific children from whom profiles are stored.

The control subsystem 220 then activates two imaging sensors positioned to have a field of view encompassing the two seats. The imaging sensors acquire image and/or motion data and communicate these data to the control subsystem 220. The control subsystem 220 compares the newly received data to information stored in the child profiles or elsewhere pertaining to facial recognition, joint skeletal relationships, or the like and confirms on that basis the presence and identities of the two seated children.

The control subsystem 220 directs two video screens, one each deployed in a convenient viewing area for each child, to display a welcome message, each customized to the respective child. The two video screens can be regarded as elements of a response subsystem 300 which can include speakers or other devices. The control subsystem 220 continues receiving imaging data from the two imaging sensors and separately compares the received data to a gesture command library. The system 200 determines, based on data stored in the child profiles or elsewhere that a relatively small number of gesture commands can be considered executable when detected issued by the two year old, while a larger number of gesture commands can be considered executable when issued by the five year old.

The two year old issues a first hand gesture, such as a clap or a thumbs up to bring up on the display four images relating to four videos the child may watch. The child points at one of the images and that video begins playing. The five year old issues a first hand gesture, such as a clap or a thumbs up to bring up on the display a scroll bar to enable scrolling through a variety of images relating to videos or music the child may select. The child conducts a series of lateral swipe gestures to scroll through the images and ultimately points at the image pertaining to the content he wishes to select. The control subsystem 220 directs the response subsystem to play the selected content.

Subsequently, the five year old feels uncomfortably cold, wraps his arms around himself, and grimaces. The control subsystem 220, upon receiving this information from the relevant imaging sensor of the detection subsystem, directs the vehicles temperature control system to send warm air through vents located near that child's seat.

It should be understood that the scenario described above is exemplary only, and is not intended to describe all uses or operations of the system 200. Nor is this scenario intended to suggest that the all uses or operations described therein are will be present in different embodiments. Further, the sequence of operations above could be different, and various operations could be separated from one another or merged.

Also disclosed is a method for enabling child control of vehicle functions. The method includes a step of equipping a control system 200, for installation in a vehicle 100, with a detection subsystem 210 and a control subsystem 220. The detection subsystem 210 can include at least one child detection sensor 212 and at least one command sensor 214 and the control subsystem 220 can be configured to enable a child to control at least one vehicle function. Typically the method is performed such that the detection subsystem 210 is operable to detect a command such as a hand gesture command issued by a child. The detection subsystem 210 can also be configured to transmit command data to the control subsystem 220. Typically, the control subsystem 220 is operable to receive and interpret the command data transmitted by the detection subsystem 210. Upon interpreting command data, the command subsystem 220 can then issue execution instructions to a response subsystem 300. In particular characteristics, the system 200, detection subsystem 210, command subsystem 220, and response subsystem 300 as used with the method are as described above.

Also considered to be specifically within the scope of the disclosure is a vehicle 100 having a system 200 of the type described above. The vehicle 100 can be a car, van, truck, or any motor vehicle which can ordinarily be used to transport children.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A system for a vehicle, comprising:
a detection subsystem configured to detect the presence of a child in a vehicle passenger seat and to detect commands issued by the child; and
a control subsystem in communication with the detection subsystem and configured to enable a child to control at least one vehicle function.

2. The system as recited in claim 1, further comprising at least one response subsystem.

3. The system as recited in claim 2, wherein the at least one response subsystem comprises any of an audio function, a video function, and an audiovisual function.

4. The system as recited in claim 1, wherein the detection subsystem comprises:
at least one child detection sensor; and
at least one command sensor.

5. The system as recited in claim 1, wherein the at least one command sensor is configured to detect a gesture command.

6. The system as recited in claim 1, wherein the at least one command sensor comprises an imaging sensor.

7. The system as recited in claim 1, wherein the control subsystem has access to a gesture command library.

8. The system as recited in claim 1, further comprising at least one child profile which contains identification and permissions data relevant to a specific child.

9. A method for enabling child control of vehicle functions, the method comprising:
equipping a control system, for installation in a vehicle, with:
a detection subsystem comprising at least one child detection sensor and at least one command sensor; and
a control subsystem configured to enable a child to control at least one vehicle function;
wherein the detection subsystem is operable to transmit command data to the control subsystem and the control subsystem is operable to receive and interpret the command data.

10. A vehicle having a system configured to enable a child to control vehicle functions, the system comprising:
a detection subsystem configured to detect the presence of a child in a vehicle passenger seat and to detect user commands; and
a control subsystem in communication with the detection subsystem and configured to enable a user to control at least one vehicle function.

11. The vehicle as recited in claim 10, wherein the system further comprises at least one response subsystem.

12. The vehicle as recited in claim 11, wherein the at least one response subsystem comprises any of an audio function, a video function, and an audiovisual function.

13. The vehicle as recited in claim 10, wherein the detection subsystem comprises:
at least one child detection sensor; and
at least one command sensor.

14. The vehicle as recited in claim 10, wherein the at least one command sensor is configured to detect a gesture command.

15. The vehicle as recited in claim 10, wherein the at least one command sensor comprises an imaging sensor.

16. The vehicle as recited in claim 10, wherein the control subsystem has access to a gesture command library.

17. The vehicle as recited in claim 10, further comprising at least one child profile which contains identification and permissions data relevant to a specific child.
